(19) United States
(12) Patent Application Publication
(10) Pub. No.: US 2015/0081987 A1
(43) Pub. Date: Mar. 19, 2015

(54) DATA SUPPLY CIRCUIT, ARITHMETIC PROCESSING CIRCUIT, AND DATA SUPPLY METHOD

(71) Applicants: FUJITSU LIMITED, Kawasaki-shi (JP); FUJITSU SEMICONDUCTOR LIMITED, Yokohama-shi (JP)

(72) Inventors: Yi GE, Bunkyo (JP); Kazuo HORIO, Yokohama (JP); Hiroshi HATANO, Kawasaki (JP)

(73) Assignees: FUJITSU LIMITED, Kawasaki-shi (JP); FUJITSU SEMICONDUCTOR LIMITED, Yokohama-shi (JP)

(21) Appl. No.: 14/474,711

(22) Filed: Sep. 2, 2014

(30) Foreign Application Priority Data
Sep. 17, 2013 (JP) 2013-191570

(51) Int. Cl. G06F 3/06; G06F 9/30

(52) U.S. Cl. CPC G06F 3/0656; G06F 9/3001; G06F 3/0604; G06F 3/0673
USPC 711/154

(57) ABSTRACT

An data supply circuit includes a buffer configured to store a plurality of data items each having a first width, a memory access unit configured to read source data stored in memory and to store the source data as one or more data items each having the first width in the buffer, and a selection control unit configured to repeat multiple times an operation of reading a data item having a second width shorter than or equal to the first width to read a plurality of data items each having the second width contiguously and sequentially from the buffer and configured to continue to read from a head end of the source data upon a read portion reaching a tail end of the source data.

### CROSS-REFERENCE TO RELATED APPLICATIONS

The present application is based upon and claims the benefit of priority from the prior Japanese Patent Application No. 2013-191570 filed on Sep. 17, 2013, with the Japanese Patent Office, the entire contents of which are incorporated herein by reference.

### FIELD

The disclosures herein relate to a data supply circuit, an arithmetic processing circuit, and a data supply method.

### BACKGROUND

A large number of matrix computations are performed in signal processing for wireless communication. Especially, the LTE (long term evolution)-advanced that is expected to be a next generation high-speed signal processing system for wireless communication has matrix computations accounting for a significant proportion in its total computation. Because of this, the use of a typical CPU (central processing system) alone may not be sufficient to complete a desired computation within a desired processing time since such a CPU is not suited for complex computations such as matrix computation.

In general, a circumstance that requires performing a process with a heavy computational load such as a matrix computation is coped with by employing a dedicated circuit for such a process. The configuration that uses a dedicated circuit, however, cannot cope with even a slight change in the processing method. When universal applicability is taken into account, a SIMD (i.e., single instruction multiple data) architecture is suited to deal with array data as used in matrix computations.

In the SIMD-type architecture, generally, a unit of data may be 32-bit scalar data. In the case of a system in which the SIMD width is four, a vector having a length of 4 in which 4 scalar data are arranged side by side is used, and the four elements of the vector are processed in parallel to perform high-speed computation. Such a SIMD-type architecture generally employs a unit data length of 32 bits, a SIMD width of 4, and a data processing width P of 128 (=4×32), for example.

Processors based on a stream (array) processing architecture that can handle not only scalar data but also a matrix and a vector as a data unit have been under development. In such a processor based on the stream processing architecture, a hardware configuration may be arranged such that the unit data length and SIMD width are treated as variable parameters, thereby making it possible to define instructions for various unit data lengths. In this hardware configuration, a unit data length UL and a SIMD width SIMD define a data processing width P (=UL×SIMD) that varies depending on the computation instruction.

### [Patent Document 1] Japanese Laid-open Patent Publication No. 11-312085

### [Patent Document 2] Japanese Laid-open Patent Publication No. 2008-77590

### [Patent Document 3] Japanese Laid-open Patent Publication No. 2012-072237

### [Patent Document 4] Japanese Laid-open Patent Publication No. 2012-066430

### [Patent Document 5] Japanese Laid-open Patent Publication No. 2013-056569

### SUMMARY

According to an aspect of the embodiment, a data supply circuit includes a buffer configured to store a plurality of data items each having a first width, a memory access unit configured to read source data stored in memory and to store the source data as one or more data items each having the first width in the buffer, and a selection control unit configured to repeat multiple times an operation of reading a data item having a second width shorter than or equal to the first width to read a plurality of data items each having the second width contiguously and sequentially from the buffer and configured to continue to read from a head end of the source data upon a read portion reaching a tail end of the source data.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the configuration of an arithmetic processing apparatus;

FIG. 2 is a drawing illustrating an example of the configuration of an arithmetic processing circuit;

FIG. 3 is a drawing illustrating an example of an arithmetic operation performed by an arithmetic data path;

FIG. 4 is a drawing illustrating an example of an arithmetic operation performed by the arithmetic data path;

FIG. 5 is a drawing illustrating an example of the configuration of a data supply circuit;

FIG. 6 is a flowchart illustrating an example of the operation of the arithmetic processing circuit illustrated in FIG. 2 and FIG. 5;

FIG. 7 is a drawing schematically illustrating the operations of a memory access unit and the data supply circuit;

FIG. 8 is a drawing schematically illustrating the operations of a memory access unit and the data supply circuit;

FIG. 9 is a drawing illustrating an example of the configuration of a selection control unit;

FIG. 10 is a drawing illustrating an example of a selection operation performed by a control circuit;

FIG. 11 is a drawing illustrating another example of the selection operation performed by the control circuit;

FIG. 12 is a drawing illustrating yet another example of a selection operation performed by the control circuit;

FIG. 13 is a drawing showing an example of the configuration of the control circuit;

FIG. 14 is a drawing illustrating an example of the configuration of a SEL_WRAP circuit;

FIG. 15 is a drawing illustrating an example of the configuration of an ADD_OFFSET circuit;

FIG. 16 is a drawing illustrating signal generation logic in the case of SLS≦M;

FIG. 17 is a drawing illustrating signal generation logic in the case of SLS>M;

FIG. 18 is a drawing illustrating another example of the configuration of the control circuit;

FIG. 19 is a drawing illustrating an example of data of an SLS_MOD table; and

FIG. 20 is a drawing illustrating another example of the configuration of the arithmetic processing circuit.

### DESCRIPTION OF EMBODIMENTS

In the following, embodiments of the invention will be described with reference to the accompanying drawings.

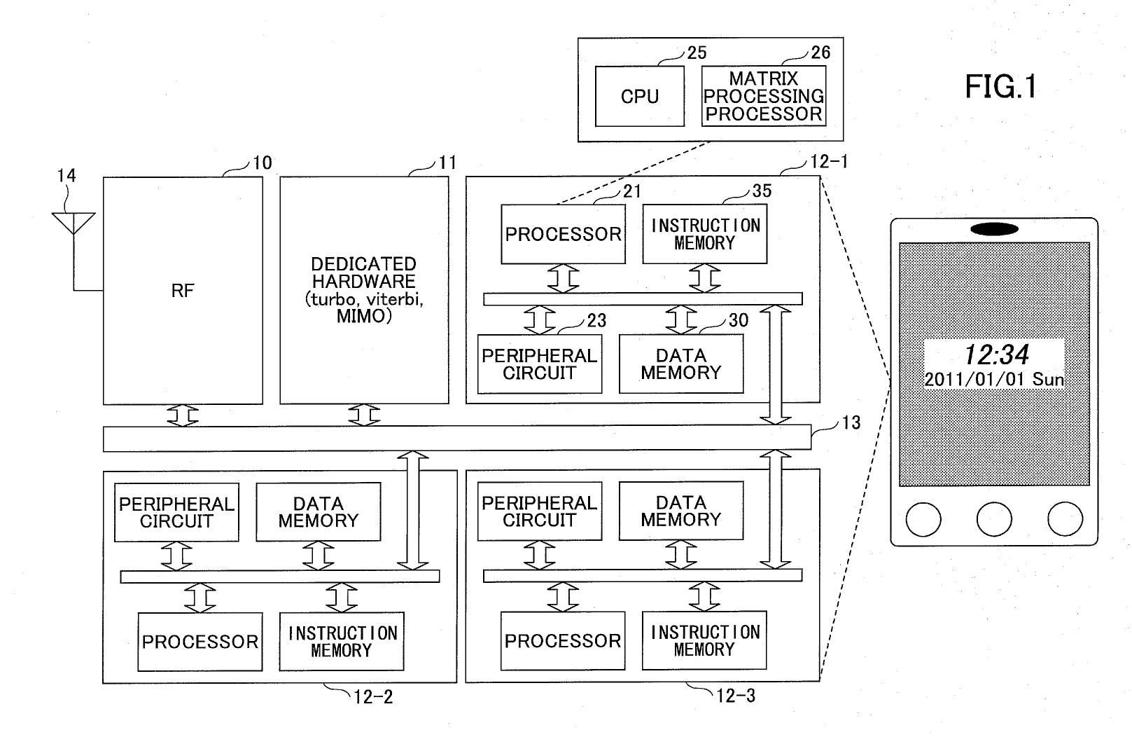

FIG. 1 is a drawing illustrating an example of the configuration of an arithmetic processing apparatus. In the example illustrated in FIG. 1, the arithmetic processing apparatus is applied to a baseband processing LSI (large scale integrated circuit) for a portable phone. The arithmetic processing apparatus serving as a baseband processing LSI includes an RF unit 10, a dedicated hardware 11, and DSPs (i.e., digital signal processors) 12-1 through 12-3.

In FIG. 1 and the subsequent drawings, boundaries between functional or circuit blocks illustrated as boxes basically indicate functional boundaries, and may not correspond to separation in terms of physical positions, separation in terms of electrical signals, separation in terms of control logic, etc. Each functional or circuit block may be a hardware module that is physically separated from other blocks to some extent, or may indicate a function in a hardware module in which this and other blocks are physically combined together.

The RF unit 10 down-converts the frequency of a radio signal received by an antenna 14, and converts the down-converted analog signal to a digital signal for transmission to a bus 13. The RF unit 10 converts a digital signal supplied through the bus 13 into an analog signal, and up-converts the analog signal into a radio-frequency signal for transmission through the antenna 14.

The dedicated hardware 11 includes a turbo unit for handling error correction codes, a viterbi unit for performing a viterbi algorithm, a MIMO (i.e., multi input multi output) unit for transmitting and receiving data through a plurality of antennas, and so on.

Each of the DSPs 12-1 through 12-3 includes a processor 21, a program memory 35, a peripheral circuit 23, and a data memory 30. The processor 21 includes a CPU 25 and a matrix processing processor 26. Various processes of the wireless communication signal processing such as a searcher process (synchronization), a demodulator process (demodulation), a decoder process (decoding), a codec process (coding), a modulator process (modulation), and the like are assigned to the DSPs 12-1 through 12-3.

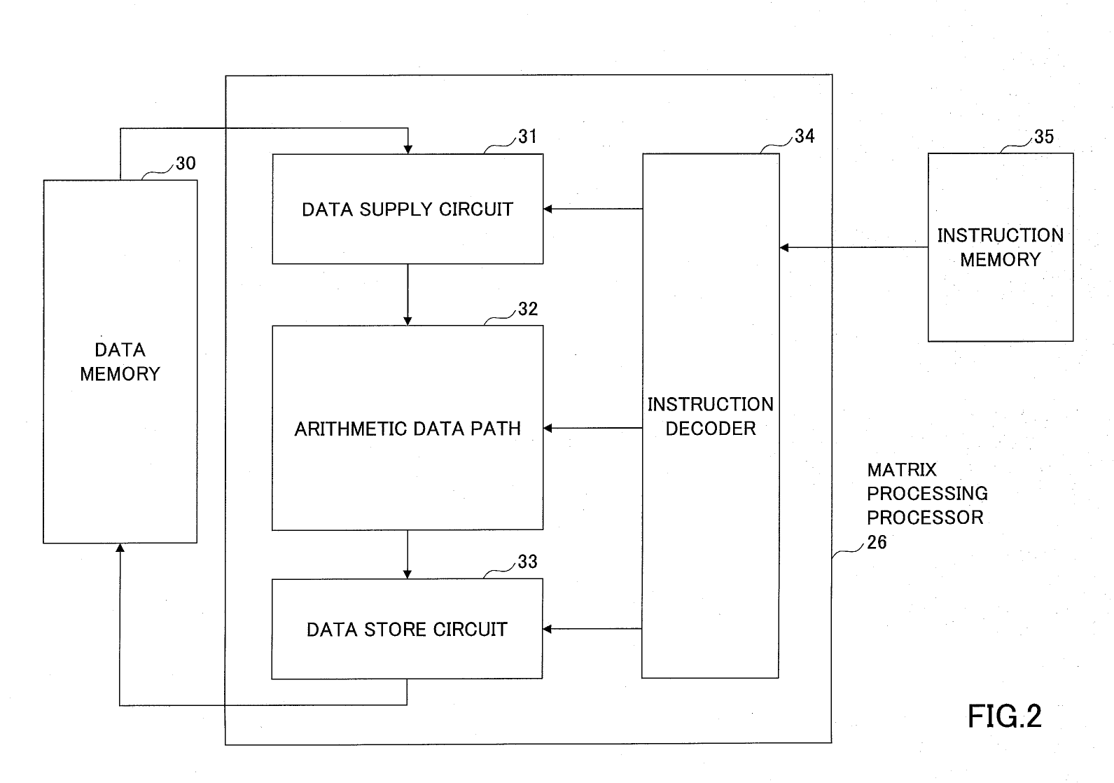

FIG. 2 is a drawing illustrating an example of the configuration of an arithmetic processing circuit. The arithmetic processing circuit illustrated in FIG. 2 corresponds to the matrix processing processor 26, the data memory 30, and the program memory (i.e., instruction memory) 35 of the arithmetic processing apparatus illustrated in FIG. 1.

The arithmetic processing circuit includes the data memory 30, a data supply circuit 31, an arithmetic data path (i.e., data arithmetic unit) 32, a data store circuit 33, an instruction decoder 34, and an instruction memory 35. The data supply circuit 31 is connected to the data memory 30, and reads data from the data memory 30. The arithmetic data path 32 is connected to the data supply circuit 31, and performs an arithmetic operation with respect to the data supplied from the data supply circuit 31. The data store circuit 33 is connected to the arithmetic data path 32 and to the data memory 30, and writes to the data memory 30 the resultant data of the arithmetic operation supplied from the arithmetic data path 32. The instruction memory 35 stores an instruction series comprised of a plurality of instructions, which are successively supplied to the instruction decoder 34. The instruction decoder 34 decodes supplied instructions to control the data supply circuit 31, the arithmetic data path 32, and the data store circuit 33 according to the decode results, thereby causing access to be made to the data memory 30 and arithmetic operations to be performed by the arithmetic data path 32.

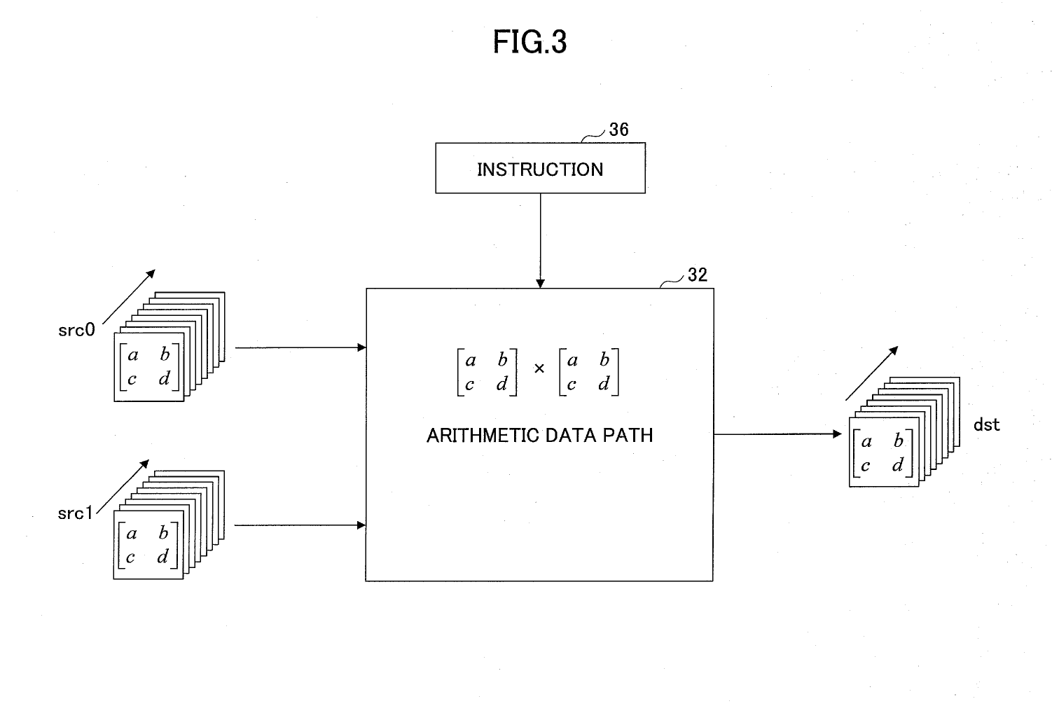

FIG. 3 is a drawing illustrating an example of an arithmetic operation performed by the arithmetic data path 32. Each of first source data src0 and second source data src1 is a 2×2 matrix. The length of minimum indivisible data, i.e., the length of unit data, is 1 short, which is equal to 16 bits. Each element of a matrix is 1 short, so that a 2×2 real-number matrix can be represented by 4 shorts. Further, a 2×2 complex-number matrix can be represented by 8 shorts. One matrix serves as a unit for an arithmetic operation. An arithmetic unit length UL is thus 4 shorts in the case of a 2×2 real-number matrix, and is 8 shorts in the case of a 2×2 complex-number matrix.

In the example illustrated in FIG. 3, the arithmetic data path 32 calculates a multiplication between two matrices according to the result of decoding an instruction 36. The arithmetic data path 32 is based on the SIMD-type architecture, and performs arithmetic operations identified by an instruction with respect to a plurality of data. For example, the arithmetic data path 32 may receive four matrices of the first source data src0 and four matrices of the second source data src1 to perform multiplications of respective matrices, thereby outputting four matrices of destination data dst as results of the arithmetic operations. In this matrix arithmetic operations, a multiplication of the first respective matrices of the two source data, a multiplication of the second respective matrices, a multiplication of the third respective matrices, and a multiplication of the fourth respective matrices are performed in parallel to each other. The SIMD width in this case is 4. Namely, the SIMD width is equal to the number of arithmetic units (i.e., 2×2 matrices in this example) on which arithmetic operations are performed in parallel. The data processing width P in each arithmetic cycle is equal to a product of the SIMD width and the arithmetic unit length UL.

In the arithmetic data path 32, the SIMD width and the arithmetic unit length UL may be variables which can be set. Namely, the SIMD width and the arithmetic unit length UL may be different in arithmetic operations on an instruction-by-instruction basis.

The data length of the source data, i.e., the total length of the source data subjected to arithmetic operations, is referred to as a stream length SLS. When the arithmetic unit is a 2×2 real-number matrix (i.e., the arithmetic unit length UL is 4 shorts) and 1000 matrices are subjected to arithmetic operations, for example, the stream length SLS is 4000 shorts.

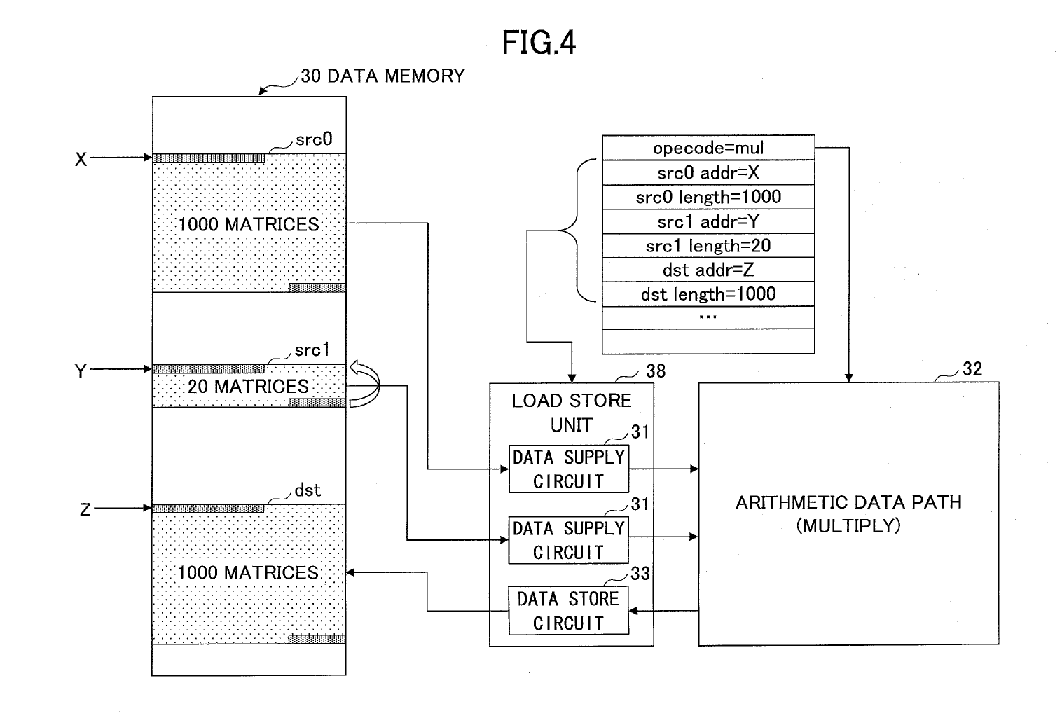

FIG. 4 is a drawing illustrating an example of an arithmetic operation performed by the arithmetic data path 32. In FIG. 4, the same or corresponding elements as those of FIG. 2 are referred to by the same or corresponding numerals, and a description thereof will be omitted as appropriate. In FIG. 4, two data supply circuits 31 and one data store circuit 33 are illustrated as one load store unit 38. As illustrated in FIG. 4, data supply circuits 31 are provided in one-to-one correspondence with respective source data (i.e., source operands). The total number of data of the first source data src0 is 1000 matrices, and the total number of data of the second source data src1 is 20 matrices. The total number of data of the destination data dst is 1000 matrices.

According to the result of decoding the instruction “opecode=mul” fetched from the instruction memory 35 (see FIG. 2), the arithmetic data path 32 is controlled to perform multiplications of respective matrices. The start address of the first source data src0 in the memory 30 is X. The data length of the first source data src0 is 1000 matrices as counted in arithmetic units. The instruction codes “src0 addr=X” and “src0 length=1000” indicating these are supplied to the first data supply circuit 31, which, in response thereto, successively reads 1000 matrices from start address X and subsequent addresses. The start address of the second source data src1 in the memory 30 is Y. The data length of the second source data src1 is 20 matrices as counted in arithmetic units. The instruction codes “src1 addr=Y” and “src1 length=20” indicating these are supplied to the second data supply circuit 31, which, in response thereto, successively reads 20 matrices from start address Y and subsequent addresses.

The address at which the storing of the destination data dst starts in the memory 30 is Z. The data length of the destination data dst is 1000 matrices as counted in arithmetic units. The instruction codes “dst addr=Z” and “dst length=1000” indicating these are supplied to the data store circuit 33, which, in response thereto, successively writes 20 matrices to start address Z and subsequent addresses.

Since the data length of the destination data dst is 1000 matrices, i.e., the data length of arithmetic operation outputs is 1000 matrices, matrix arithmetic operations by the arithmetic data path 32 are performed until 1000 matrices are output. As for the first source data src0, a total data length of 1000 matrices is equal to the data length of arithmetic operation outputs. Accordingly, it suffices for the data supply circuit 31 to successively read matrix data of the first source data src0 from the first matrix to the last matrix and to supply these matrix data to the arithmetic data path 32. As for the second source data src1, a total data length of 20 matrices is shorter than the data length of arithmetic operation outputs. Accordingly, the data supply circuit 31 successively reads matrix data of the second source data src1 from the first matrix to the last matrix, followed by returning to the first matrix to repeat successively reading matrix data from the first matrix to the last matrix. In this manner, the data supply circuit 31 repeats the operation of successively reading 20 matrices to supply the retrieved data to the arithmetic data path 32. When the number of repetitions of reading the second source data src1 reaches 50, the total number of retrieved matrices is 1000, which is equal to 20 matrices multiplied by 50 times. With this, the read operation comes to an end.

As another example, the data length of the first source data src0 may be 1000 matrices, and the data length of the second source data src1 is 20 matrices, with the data length of the destination data dst being 2000 matrices. In this case, the data supply circuit 31 successively reads matrix data of the first source data src0 from the first matrix to the last matrix, followed by returning to the first matrix to repeat successively reading matrix data from the first matrix to the last matrix. When the number of repetitions of reading the first source data src0 reaches 2, the total number of retrieved matrices is 2000, which is equal to 1000 matrices multiplied by 2 times. With this, the read operation comes to an end. When the number of repetitions of reading the second source data src1 reaches 100, the total number of retrieved matrices is 2000, which is equal to 20 matrices multiplied by 100 times. With this, the read operation comes to an end.

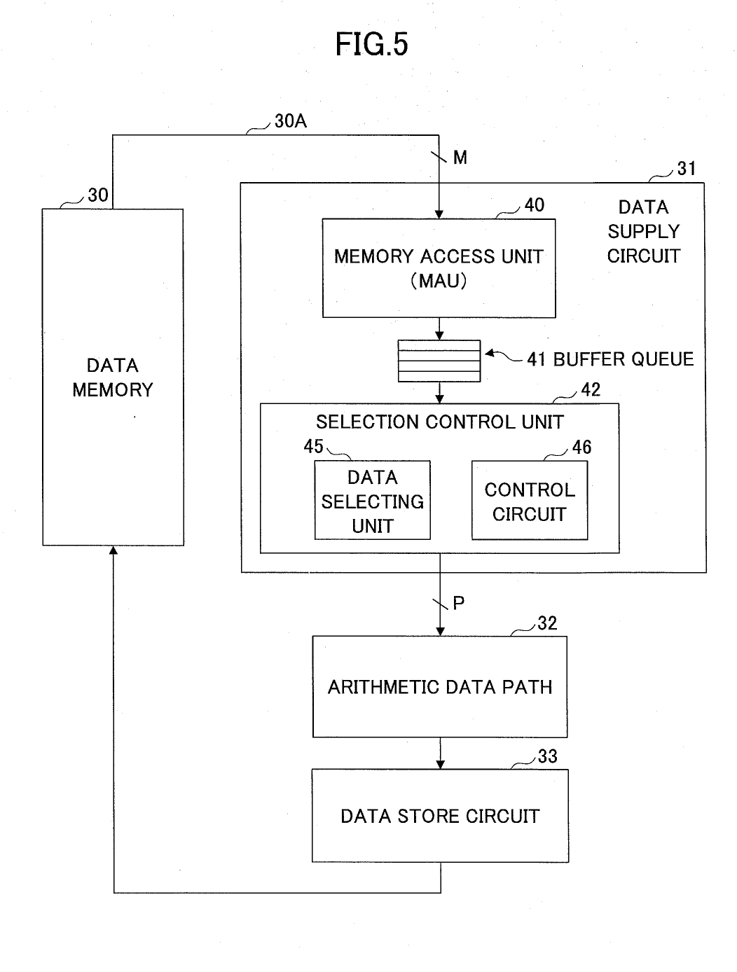

FIG. 5 is a drawing illustrating an example of the configuration of the data supply circuit 31. In FIG. 5, the same or corresponding elements as those of FIG. 2 are referred to by the same or corresponding numerals, and a description thereof will be omitted as appropriate.

In FIG. 5, the data supply circuit 31 includes a memory access unit (MAU) 40, a buffer queue 41, and a selection control unit 42. The buffer queue 41 is a FIFO (first in first out) which can store a plurality of data items each having a width of M shorts (M: positive integer). The memory access unit 40 reads data having a data length SLS (short) stored in the data memory 30, and stores the retrieved data as one or more data items each having the width M (short) in the buffer queue 41. Specifically, the memory access unit 40 reads M (short) data items equal in width to one line of the data memory 30, i.e., equal in width to the width of a bus 30A, from the top of the data having the data length SLS (short) stored in the data memory 30. The memory access unit 40 writes to the buffer queue 41 the data having the width M received through the bus 30A having the width M. The buffer queue 41 allows data items each having the width M to be successively stored therein, and allows the data items each having the width M to be successively read therefrom with the earliest stored data first.

The selection control unit 42 includes a data selecting unit 45 and a control circuit 46. The selection control unit 42 successively repeats the operation of reading data having a width P by selecting P (≦M) (short) consecutive unit data items from the buffer queue 41, thereby reading data items each having the width P contiguously and sequentially from the buffer queue 41. Specifically, the selection control unit 42 first selects P (≦M) (short) consecutive unit data items sequentially from the top of the M unit data items having the width M that were most early stored in the buffer queue 41. The selection control unit 42 may supply the P selected unit data items to the arithmetic data path 32. In the case of the data transfer width being fixed (e.g., width M) between the selection control unit 42 and the arithmetic data path 32, the selection control unit 42 may supply data having the width M inclusive of the P selected unit data items to the arithmetic data path 32. The M-P unit data items other than the P selected unit data items may be any data whose value does not matter.

After selecting the P consecutive unit data items, the selection control unit 42 newly selects P consecutive unit data items sequentially from the unit data item next following the last unit data item that was already selected, and supplies the P newly selected unit data items to the arithmetic data path 32. Repeating the above-noted operation, the selection control unit 42 successively reads a plurality of data items each having the width P contiguously from the buffer queue 41. At some point, a unit data item selected by the selection control unit 42 may be the last unit data item of the data having width M. In such a case, the next following data having the width M is retrieved from the buffer queue 41, followed by continuing to select the first unit data item and subsequent unit data items of this newly retrieved data having the width M.

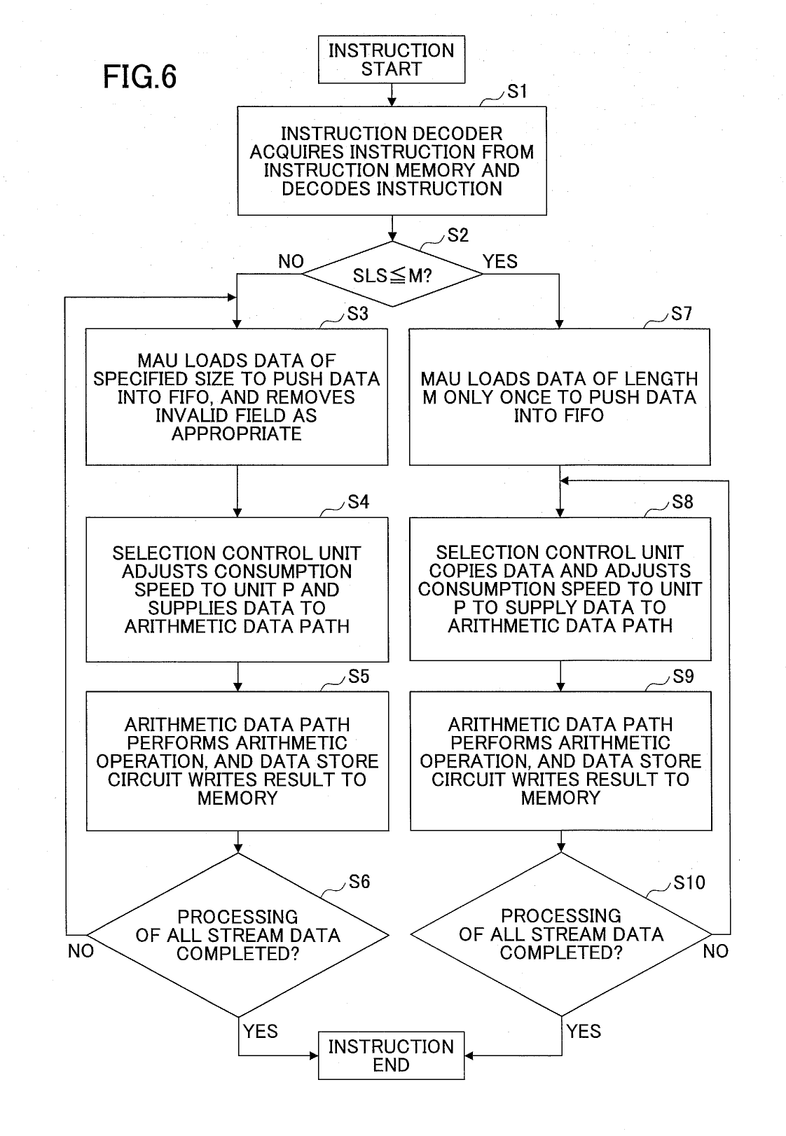

FIG. 6 is a flowchart illustrating an example of the operation of the arithmetic processing circuit illustrated in FIG. 2 and FIG. 5. It may be noted that, in FIG. 6, an order in which the steps illustrated in the flowchart are performed is only an example. The scope of the disclosed technology is not limited to the disclosed order. For example, a description may explain that an A step is performed before a B step is performed. Despite such a description, it may be physically and logically possible to perform the B step before the A step while it is possible to perform the A step before the B step. In such a case, all the consequences that affect the outcomes of the flowchart may be the same regardless of which step is performed first. It then follows that, for the purposes of the disclosed technology, it is apparent that the B step can be performed before the A step is performed. Despite the explanation that the A step is performed before the B step, such a description is not intended to place the obvious case as described above outside the scope of the disclosed technology. Such an obvious case inevitably falls within the scope of the technology intended by this disclosure.

In step S1 of FIG. 6, the instruction decoder 34 acquires an instruction from the instruction memory 35 to decode the instruction. In step S2, the memory access unit 40 checks whether the stream length SLS of the source data to be accessed is shorter than or equal to M. In the case of SLS is longer than M, in step S3, the memory access unit 40 loads data src0 of an indicated size, and pushes the loaded data into the FIFO of the buffer queue 41. This indicated size may be equal to the maximum data size storable in the buffer queue 41 or smaller. Specifically, the memory access unit 40 may successively store in the buffer queue 41 a plurality of data items each having the width M obtained by dividing the data of the stream length SLS.

As long as the loaded data is not the last one of the source data having the stream length SLS, the loaded data having the width M are successively stored in the buffer queue 41. When the loaded data is the last one of the source data having the stream length SLS, the source data may be present only in part of the data having the width M retrieved through the bus. In such a case, the invalid field (i.e., the bit field where no source data is present) is removed. To be more specific, when there is an invalid field in data having the width M that include the last one of the source data having the stream length SLS, the head part of the source data that is read in the next one of the repetitive cycles is used to fill the invalid field.

In step S4, the selection control unit 42 supplies data to the arithmetic data path 32 by adjusting the speed of data consumption to the unit of P. Namely, the selection control unit 42 retrieves data of the width P from the buffer queue 41 in each arithmetic operation cycle to supply the retrieved data to the arithmetic data path 32. With this arrangement, data having the data processing width P subjected to an arithmetic operation is supplied in each arithmetic operation cycle from the data supply circuit 31 to the arithmetic data path 32.

In step S5, the arithmetic data path 32 performs an indicated arithmetic operation in accordance with the decode result obtained in step S1. Further, the data store circuit 33 stores the resultant data of the arithmetic operation in the data memory 30. In step S6, the memory access unit 40, for example, checks whether the processing of all the data of the stream length SLS is completed. In the case of the processing of all the data being not completed, the procedure goes back to step S3 for further execution of the subsequent steps.

The check as to whether the processing of all the stream data is completed may be dependent on the number of output data items of arithmetic operation results. As was previously described, when the data length of the first source data src0 is 1000 matrices, and the data length of the destination data dst is 2000 matrices, the first source data src0 is read twice. In such a case, all the data of the stream length SLS are read the first time, and are then read the second time in the case of SLS being longer than M. In this manner, in the operation of contiguously reading a plurality of data items each having the width P sequentially from a plurality of data items each having the width M stored in the buffer queue 41, the event that data reading reaches the end of the data of the data length SLS can trigger an action of continuing to read data from the head of the data of the data length SLS.

In the case of the check in step S6 indicating that the processing of all the data is completed, the procedure for the instruction decoded in step S1 comes to an end.

In the case of the check in step S2 indicating that SLS is shorter than or equal to M, in step S7, the memory access unit 40 loads data of the width M only once, and pushes the loaded data into the FIFO of the buffer queue 41. Namely, the memory access unit 40 stores the data having the width M inclusive of the data of the stream length SLS only once in the buffer. Since SLS is shorter than or equal to M, only one load and push operation serves to store all the source data in the buffer queue 41.

In step S4, the selection control unit 42 supplies data to the arithmetic data path 32 by copying the data and adjusting the speed of data consumption to the unit of P. Namely, the selection control unit 42 retrieves data of the width P from the buffer queue 41 in each arithmetic operation cycle to supply the retrieved data to the arithmetic data path 32. To be more specific, the selection control unit 42 successively reads a plurality of data items each having the width P contiguously (i.e., without any gap) from a data portion of the one data item of the width M stored in the buffer queue 41 wherein the noted data portion corresponds to the data of the stream length SLS. When reading reaches the end of the data portion, the selection control unit 42 continues to read data from the head (i.e., start point) of the data portion. For example, Q (<P) unit data items may be selected at the end of the data portion that corresponds to the data of the stream length SLS. In such a case, further P-Q unit data items are selected sequentially from the head of such a data portion, and these P-Q unit data items are placed to follow the Q unit data items to create data of P unit data items. With this arrangement, data having the data processing width P subjected to an arithmetic operation is supplied in each arithmetic operation cycle from the data supply circuit 31 to the arithmetic data path 32.

In step S9, the arithmetic data path 32 performs an indicated arithmetic operation in accordance with the decode result obtained in step S1. Further, the data store circuit 33 stores the resultant data of the arithmetic operation in the data memory 30. In step S10, the memory access unit 40, for example, checks whether the processing of all the data of the stream length SLS is completed. In the case of the processing of all the data being not completed, the procedure goes back to step S8 for further execution of the subsequent steps. In the case of the check in step S10 indicating that the processing of all the data is completed, the procedure for the instruction decoded in step S1 comes to an end.

It may be noted that in the case of SLS being shorter than or equal to M, the memory access unit 40 loads data of the width M only once. The fact that it suffices to load data only once results in reduced power consumption.

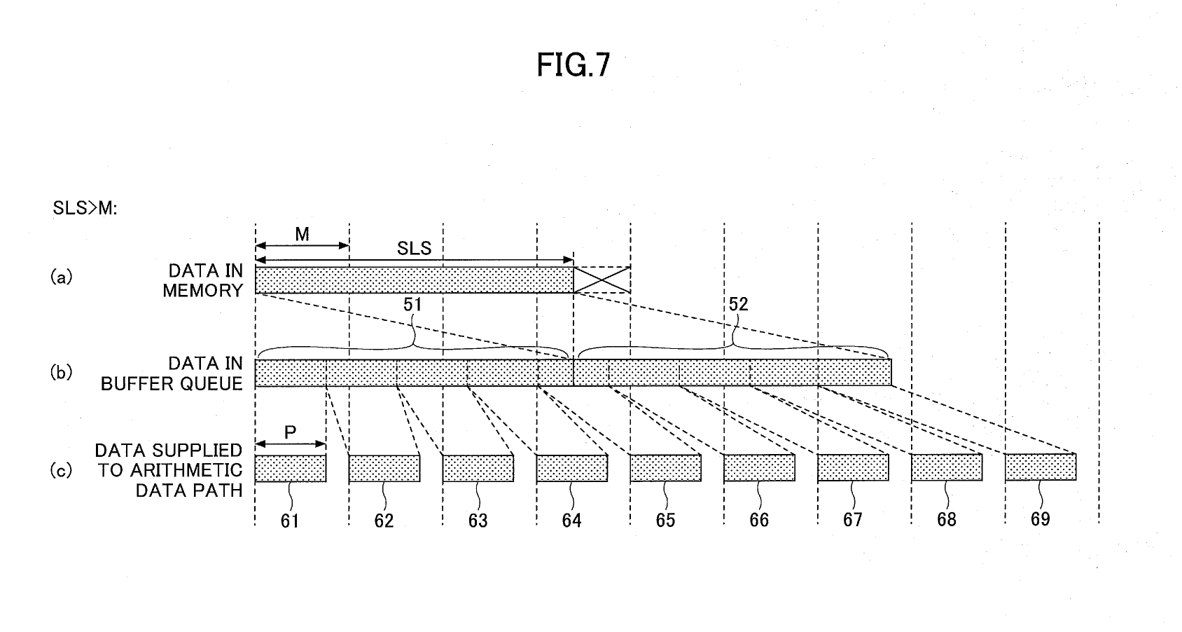

FIG. 7 is a drawing schematically illustrating the operations of the memory access unit 40 and the data supply circuit 31. The operations illustrated in FIG. 7 are performed in the case of SLS being longer than M.

As illustrated in FIG. 7-(a), data of the stream length SLS is stored in the data memory 30. The stream length SLS is longer than the width M. The data of the stream length SLS are read by the memory access unit 40 such that data of the width M is read at a time for storage in the buffer queue 41. FIG. 7-(b) illustrates data 51 stored in the buffer queue 41. The operation of reading data having the width P by selecting P (≦M) consecutive unit data items from the data stored in the buffer queue 41 is repeated multiple times, thereby reading data items 61 through 64 each having the width P contiguously and sequentially from the buffer queue 41. The data item 65 reaches the end of the data 51. Before retrieving the data item 65 having the width P, the memory access unit 40 reads data of the stream length SLS from the data memory 30 to store this read data as data 52 in the buffer queue 41. With this arrangement, a plurality of data items 61 through 69 each having the width P can be read contiguously and sequentially from the buffer queue 41. Each of the data items 61 through 69 having the width P is read in a different arithmetic operation cycle. That is, one data item is read in one arithmetic operation cycle.

In the example of an operation illustrated in FIG. 7, the data of the stream length SLS is read from the data memory 30 to be stored as the data 51 in the buffer queue 41. Subsequently, the dame data of the stream length SLS is read from the data memory 30 to be stored as the data 52 in the buffer queue 41. Instead of using the above-noted arrangement, the data 51 stored in the buffer queue 41 may be used twice, so that a data portion corresponding to the data 52 is placed in the buffer queue 41.

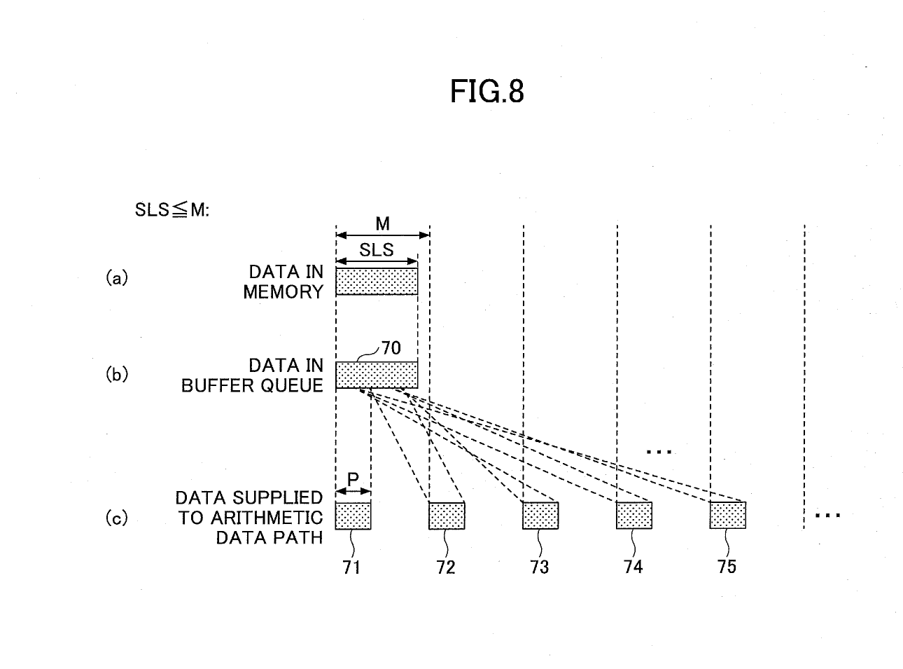

FIG. 8 is a drawing schematically illustrating the operations of the memory access unit 40 and the data supply circuit 31. The operations illustrated in FIG. 8 are performed in the case of SLS being shorter than or equal to M.

As illustrated in FIG. 8-(a), data of the stream length SLS is stored in the data memory 30. The stream length SLS is shorter than the width M. The data of the stream length SLS are loaded by the memory access unit 40 as data of the width M for storage in the buffer queue 41. FIG. 8-(b) illustrates data 70 stored in the buffer queue 41. The operation of reading data having the width P by selecting P (≦M) consecutive unit data items from the data stored in the buffer queue 41 is repeated multiple times, thereby reading data items 71 through 75 each having the width P contiguously and sequentially from the buffer queue 41. Since the data item 73 having the width P reaches the end of the data 70, the reading operation returns to the head of the data 70 to continue to select and read data from the head of the data 70. The same applies in the case of the data 75 having the width P. With this arrangement, a plurality of data items 71 through 75 each having the width P can be read contiguously and sequentially from the buffer queue 41. Each of the data items 71 through 75 having the width P is read in a different arithmetic operation cycle. That is, one data item is read in one arithmetic operation cycle.

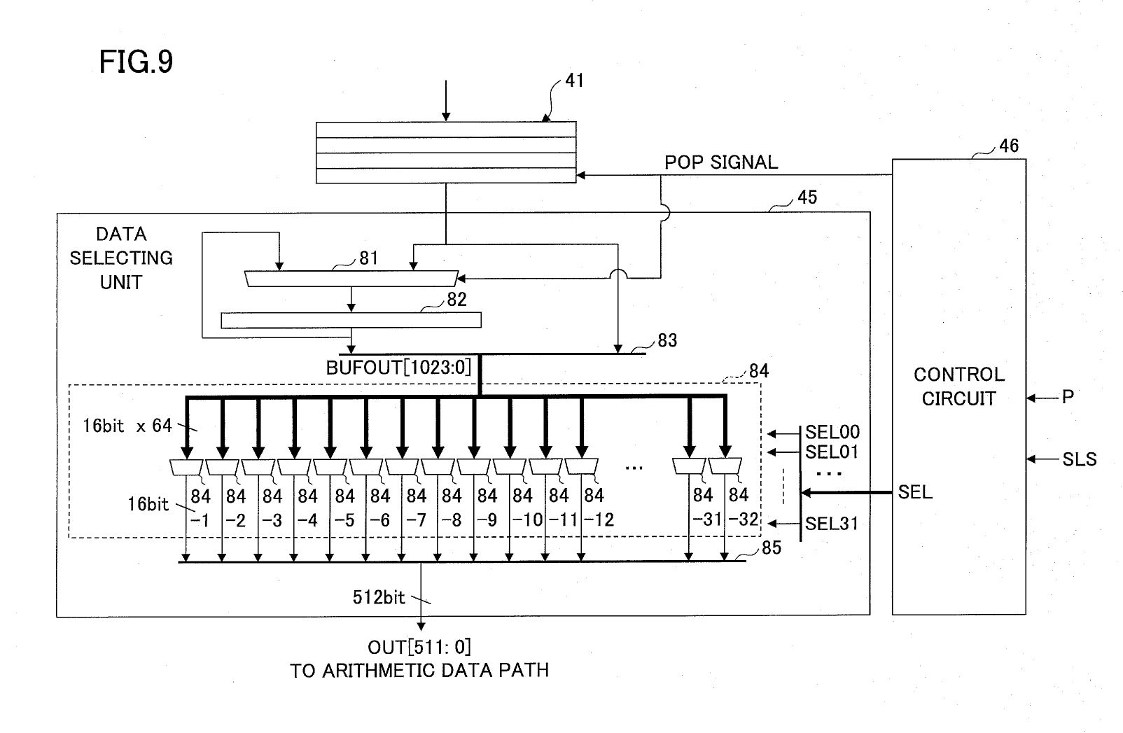

FIG. 9 is a drawing illustrating an example of the configuration of the selection control unit 42. The selection control unit 42 includes the data selecting unit 45 and the control circuit 46. The data selecting unit 45 includes a selector circuit 81, a buffer circuit 82, a combining circuit 83, a selector circuit 84, and a combining circuit 85. The selector circuit 84 includes selectors 84-1 through 84-32.

The data of the width M (32 shorts in this example) that was most early stored in the buffer queue 41 is retrieved from the buffer queue 41, in response to the “1” state of a POP signal, to be stored in the buffer circuit 82 through the selector circuit 81. At this time, the selector circuit 81 is set in the state to select the input on the right-hand side in response to the “1” state of the POP signal. With the data having a width of 32 being stored in the buffer circuit 82, the 32-short-wide data being output from the buffer queue 41 (i.e., the 32-short-wide data that was most early stored as of this moment) is the next data following the data stored in the buffer circuit 82.

In response to the “1” state of the POP signal, the memory access unit 40 may read from the data memory 30 a remaining portion of the data of the stream length SLS that is not yet stored in the buffer queue 41, thereby storing the read data in the buffer queue 41 as succeeding data. In so doing, the data read from the data memory 30 may reach the end of the data of the stream length SLS. In such a case, reading may resume from the head portion of the data of the stream length SLS in response to the next “1” state of the POP signal. In this case, as illustrated in FIG. 7-(b), data may be stored in the buffer queue 41 such that the head portion of the data of the stream length SLS follows, without a gap, the end of the data of the stream length SLS that was previously stored.

The combining circuit 83 outputs 64-short-wide data BUFOUT obtained by placing, side by side, 32-short-wide data stored in the buffer circuit 82 and next 32-short-wide data output from the buffer queue 41. The length of the data BUFOUT is 64 shorts×16 bits, which is equal to 1024 bits.

The selector circuit 84 selects P consecutive unit data items from the 64-short-wide data BUFOUT output from the combining circuit 83 as specified by selection control signals SEL00 through SEL31 that are supplied from the control circuit 46. In actuality, the output of the data selecting unit 45 is 32 shorts in width. The P selected consecutive unit data items may be situated in a contiguous part (typically in the leftmost contiguous part) of the 32-short-wide output data. The arithmetic data path 32 performs an arithmetic operation only with respect to data having the data processing width P. Accordingly, the P consecutive unit data items situated in the leftmost part, for example, of the 32-short-wide data output from the data selecting unit 45 are subjected to such an operation.

Specifically, the selector 84-1 selects and outputs, from the 64-short-wide data BUFOUT, the 1-short-wide unit data item situated at the position that is specified by the selection control signal SEL00. Further, the selector 84-2 selects and outputs, from the 64-short-wide data BUFOUT, the 1-short-wide unit data item situated at the position that is specified by the selection control signal SEL01. Similarly, the selector 84-32 selects and outputs, from the 64-short-wide data BUFOUT, the 1-short-wide unit data item situated at the position that is specified by the selection control signal SEL31.

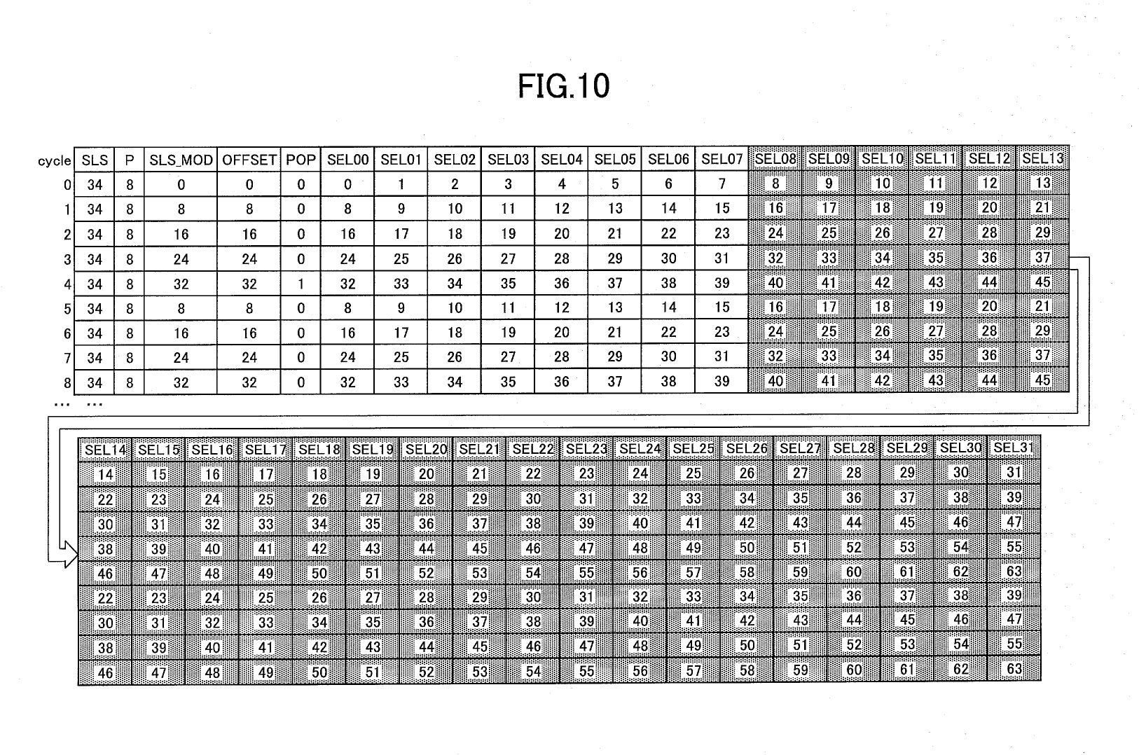

FIG. 10 is a drawing illustrating an example of the selection operation performed by the control circuit 46. In the example illustrated in FIG. 10, the width M is 32 shorts, and the stream length SLS is 34 shorts, with the data processing width P being 8 shorts. SLS_MOD and OFFSET listed in the table of FIG. 10 will be described later. Since the data processing width P is 8, only the selection control signals SEL00 through SEL07 that are supplied to the 8 leftmost selectors 84-1 through 84-8 illustrated in FIG. 9 will be taken into account in the following explanation.

32 unit data items situated at the head of the data having a stream length SLS of 34 is stored in the buffer circuit 82 illustrated in FIG. 9. The 2 remaining unit data items are stored in the leftmost part of the data that is being output from the buffer queue 41. As was previously described, in the data being output from the buffer queue 41, the 2 unit data items situated at the left-hand-side end have, as succeeding data arranged on the right-hand side thereof, the head portion (i.e., first 30 unit data items) of the data having a stream length SLS of 34. In this manner, the memory access unit 40 continues to read the data having the stream length SLS successively from the data memory 30 to store the read data in the buffer queue 41 as succeeding data.

In the first cycle (cycle=0), the selection control signals SEL00 through SEL07 are 0 through 7, respectively, so that the 0-th unit data item (i.e., leftmost item) through the 7-th unit data item (i.e., eighth item from the left) are selected from the 64-short-wide data BUFOUT. In the next cycle (cycle=1), the selection control signals SEL00 through SEL07 are 8 through 15, respectively, so that the 8-th unit data item (i.e., ninth item from the left) through the 15-th unit data item (i.e., sixteenth item from the left) are selected from the 64-short-wide data BUFOUT. Thereafter, cycles proceed similarly, such that data items each having the width P are selected and read contiguously and sequentially by utilizing the buffer circuit 82.

In the fifth cycle (cycle=4), the selection control signals SEL00 through SEL07 are 32 through 39, respectively, so that the 32-th unit data item through the 39-th unit data item are selected from the 64-short-wide data BUFOUT. At this time, the POP signal is set to “1”. Accordingly, in the next following cycle, the 2 unit data items at the end of the data having a stream length SLS of 34 and the first 30 unit data items subsequent thereto are stored in the buffer circuit 82 illustrated in FIG. 9. Further, the 4 next following unit data items at the end of the data having a stream length SLS of 34 and the head portion (i.e., the first 28 unit data items) of the data having a stream length SLS of 34 are stored side by side in the output data of the buffer queue 41.

In the sixth cycle, the selection control signals SEL00 through SEL07 are 8 through 15, respectively, so that the 8-th unit data item (i.e., ninth item from the left) through the 15-th unit data item (i.e., sixteenth item from the left) are selected from the 64-short-wide data BUFOUT. Thereafter, cycles proceed similarly, such that data items each having the width P are selected and read contiguously and sequentially.

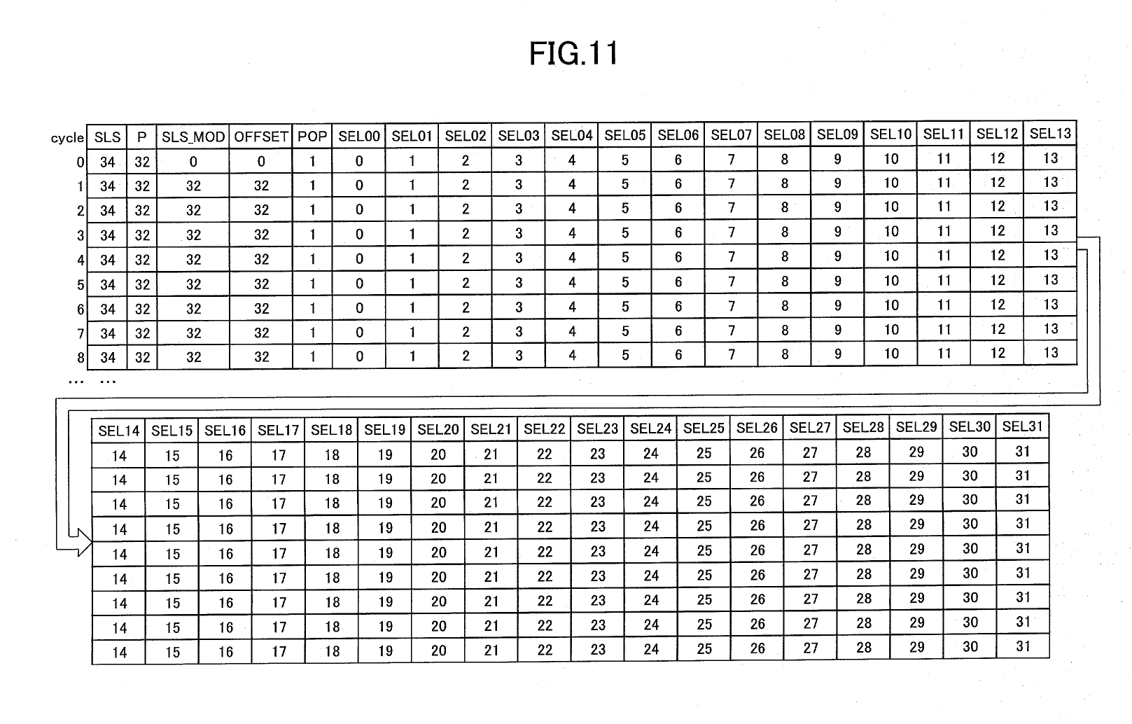

FIG. 11 is a drawing illustrating another example of the selection operation performed by the control circuit 46. In the example illustrated in FIG. 11, the width M is 32 shorts, and the stream length SLS is 34 shorts, with the data processing width P being 32 shorts. SLS_MOD and OFFSET listed in the table of FIG. 11 will be described later. Since the data processing width P is 32, the selection control signals SEL00 through SEL31 that are supplied to the 32 selectors 84-1 through 84-32 illustrated in FIG. 9 will be taken into account in the following explanation.

32 unit data items situated at the head of the data having a stream length SLS of 34 is stored in the buffer circuit 82 illustrated in FIG. 9. The 2 remaining unit data items are stored in the leftmost part of the data that is being output from the buffer queue 41. As was previously described, in the data being output from the buffer queue 41, the 2 unit data items situated at the left-hand-side end have, as succeeding data arranged on the right-hand side thereof, the head portion (i.e., first 30 unit data items) of the data having a stream length SLS of 34. In this manner, the memory access unit 40 continues to read the data having the stream length SLS successively from the data memory 30 to store the read data in the buffer queue 41 as succeeding data.

In the first cycle (cycle=0), the selection control signals SEL00 through SEL31 are 0 through 31, respectively, so that the 0-th unit data item (i.e., leftmost item) through the 31-th unit data item (i.e., rightmost item) are selected from the 64-short-wide data BUFOUT. At this time, the POP signal is set to “1”. Accordingly, in the next following cycle, the 2 unit data items at the end of the data having a stream length SLS of 34 and the first 30 unit data items subsequent thereto are stored in the buffer circuit 82 illustrated in FIG. 9. Further, the 4 next following unit data items at the end of the data having a stream length SLS of 34 and the head portion (i.e., the first 28 unit data items) of the data having a stream length SLS of 34 are stored side by side in the output data of the buffer queue 41.

In the next cycle (cycle=1) also, the selection control signals SEL00 through SEL31 are 0 through 31, respectively, so that the 0-th unit data item (i.e., leftmost item) through the 31-th unit data item (i.e., rightmost item) are selected from the 64-short-wide data BUFOUT. At this time, the POP signal is set to “1”. Accordingly, in the next following cycle, the 4 unit data items at the end of the data having a stream length SLS of 34 and the first 28 unit data items subsequent thereto are stored in the buffer circuit 82 illustrated in FIG. 9. Further, the 6 next following unit data items at the end of the data having a stream length SLS of 34 and the head portion (i.e., the first 26 unit data items) of the data having a stream length SLS of 34 are stored side by side in the output data of the buffer queue 41. Thereafter, cycles proceed similarly, such that data items each having the width P are selected and read contiguously and sequentially by utilizing the buffer circuit 82.

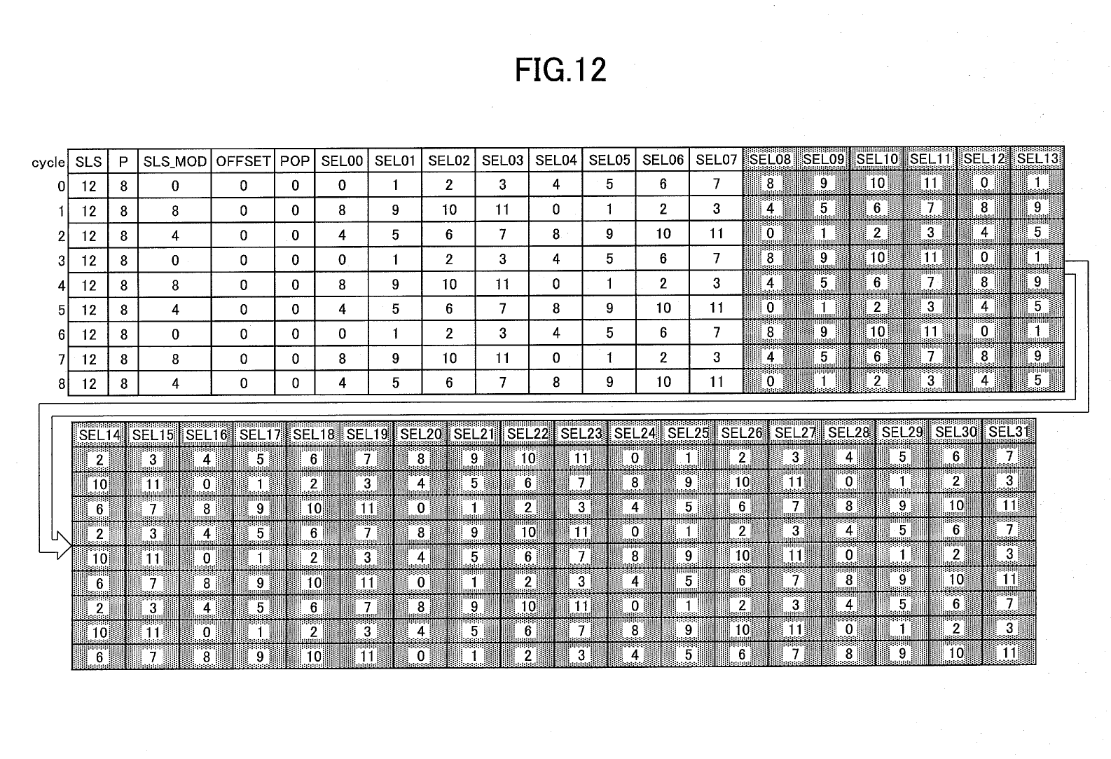

FIG. 12 is a drawing illustrating yet another example of the selection operation performed by the control circuit 46. In the example illustrated in FIG. 12, the width M is 32 shorts, and the stream length SLS is 12 shorts, with the data processing width P being 8 shorts. SLS_MOD and OFFSET listed in the table of FIG. 10 will be described later. Since the data processing width P is 8, only the selection control signals SEL00 through SEL07 that are supplied to the 8 leftmost selectors 84-1 through 84-8 illustrated in FIG. 9 will be taken into account in the following explanation.

At the beginning, the 12 unit data items of the data having a stream length SLS of 12 are stored without a gap therebetween in the leftmost side of the buffer circuit 82 illustrated in FIG. 9.

In the first cycle (cycle=0), the selection control signals SEL00 through SEL07 are 0 through 7, respectively, so that the 0-th unit data item (i.e., leftmost item) through the 7-th unit data item (i.e., eighth item from the left) are selected from the 64-short-wide data BUFOUT. In the next cycle (cycle=1), the selection control signals SEL00 through SEL07 are 8, 9, 10, 11, 0, 1, 2, and 3, respectively. Accordingly, the 8-th unit data item (i.e., ninth item from the left) through the 11-th unit data item (i.e., twelfth item from the left) and, subsequent thereto, the 0-th unit data item (i.e. leftmost item) through the 3-rd unit data item (i.e., fourth item from the left) of the 64-short-wide data BUFOUT are selected. Thereafter, cycles proceed similarly, such that data items each having the width P are selected and read contiguously and sequentially by utilizing the buffer circuit 82. In this read operation, the stream length SLS is shorter than the width M, so that the POP signal is never set to “1”.

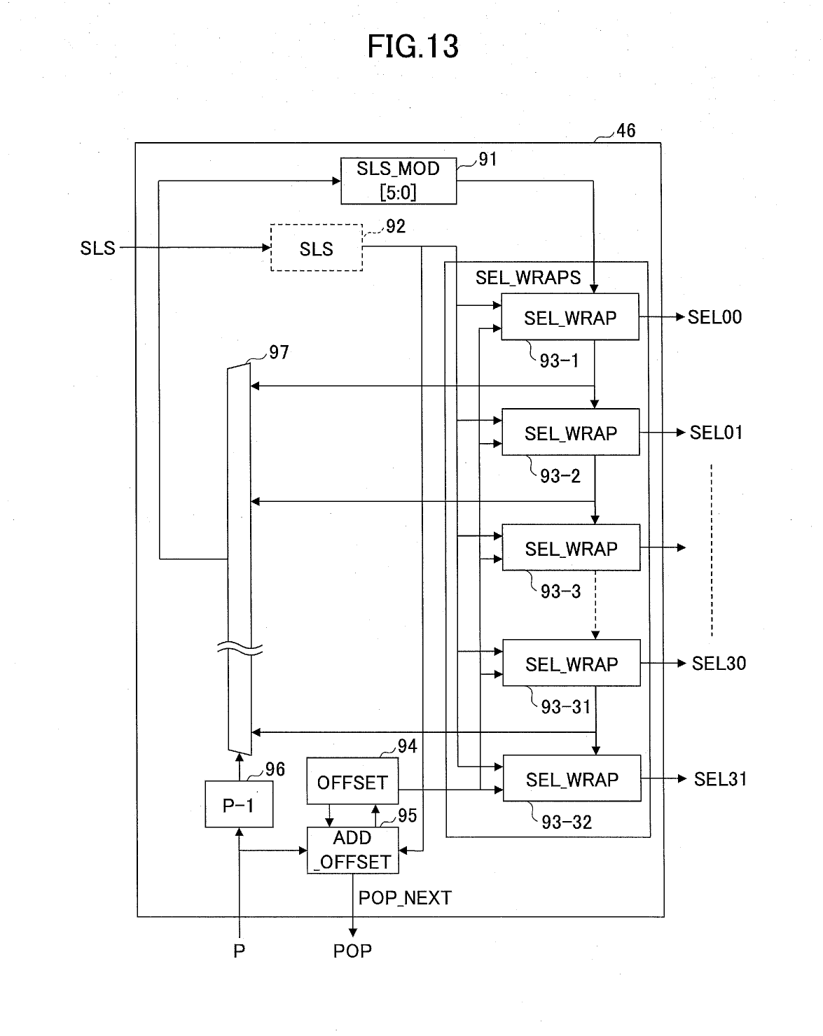

FIG. 13 is a drawing illustrating an example of the configuration of the control circuit 46. The control circuit 46 illustrated in FIG. 13 includes an SLS_MOD circuit 91, an SLS register 92, SEL_WRAP circuits 93-1 through 93-32, an OFFSET register 94, an ADD_OFFSET circuit 95, a P subtraction circuit 96, and a selector circuit 97.

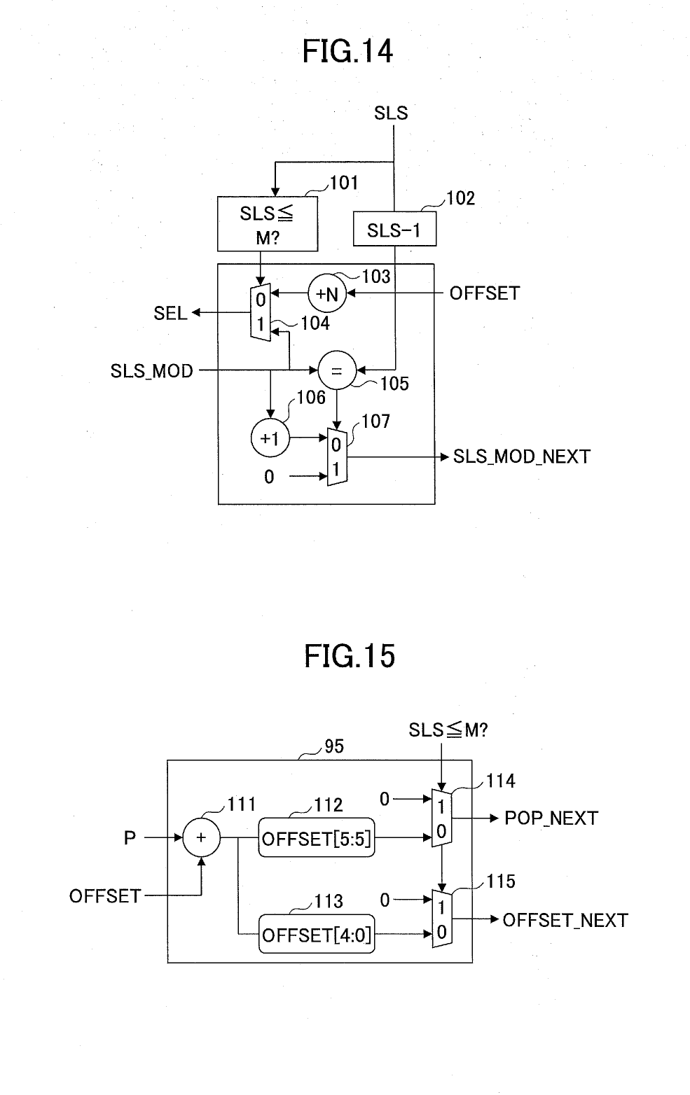

FIG. 14 is a drawing illustrating an example of the configuration of the SEL_WRAP circuit. The SEL_WRAP circuit illustrated in FIG. 14 includes an SLS check circuit 101, an SLS subtraction circuit 102, an N addition circuit 103, a selector circuit 104, a comparator circuit 105, a 1 addition circuit 106, and a selector circuit 107. In the case of the SEL_WRAP circuit 93-1, the SLS_MOD signal applied thereto is equal to the value stored in the SLS_MOD circuit 91. In the case of the SEL_WRAP circuits 93-2 through 93-32 subsequent thereto, the SLS_MOD signal applied thereto is equal to the SLS_MOD_NEXT signal output from the preceding SEL_WRAP circuit.

FIG. 15 is a drawing illustrating an example of the configuration of the ADD_OFFSET circuit. The ADD_OFFSET circuit illustrated in FIG. 15 includes an addition circuit 111, an OFFSET register 112, an OFFSET register 113, a selector circuit 114, and a selector circuit 115.

A description will be given of an example of the operation of the control circuit 46 by referring to FIG. 13 through FIG. 15 as well as FIG. 10. In the initial state, the SLS_MOD signal stored in the SLS_MOD circuit 91 is “0”. The OFFSET signal stored in the OFFSET register 94 is “0”.

In the example illustrated in FIG. 10, due to the fact that SLS is longer than M, the selector circuit 104 illustrated in FIG. 14 selects the value obtained by adding N to the value of the OFFSET signal. This value N indicates what ordinal position the SEL_WRAP circuit of interest has. The value N starts from “0”, so that the value N is “0” in the case of the 0-th SEL_WRAP circuit 93-1. In the case of the 0-th SEL_WRAP circuit 93-1, thus, the selection control signal SEL output therefrom is “0”, which is obtained by adding “0” to the value of the OFFSET signal. Further, the value “1” obtained by the 1 addition circuit 106 adding “1” to the SLS_MOD signal is output as the SLS_MOD_NEXT signal. In the case of the next SEL_WRAP circuit 93-2, the selection control signal SEL output therefrom is “1”, which is obtained by adding “1” to the value of the OFFSET signal. Further in the case of the next SEL_WRAP circuit 93-2, the SLS_MOD signal applied thereto is the SLS_MOD_NEXT signal having a value of “1” supplied from the preceding stage, so that the value of the SLS_MOD_NEXT signal output therefrom is set to “2”. The rest is similar to the above. In the case of the SEL_WRAP circuit 93-n (n: natural number), the selection control signal SEL output therefrom is “n−1”, and the SLS_MOD_NEXT signal output therefrom is “n”. In this manner, the selection control signals SEL00 through SEL31 as in the 0-th cycle illustrated in FIG. 10 are generated.

The selector circuit 97 receives SLS_MOD_NEXT output from each of the SEL_WRAP circuits 93-1 through 93-32. The selector circuit 97 further receives the value obtained by subtracting “1” from the data processing width P, i.e., “7” in this example, as a selection control signal. The selector circuit 97 selects the SLS_MOD_NEXT signal having a value of “8” output from the 7-th, as counted when the starting number is “0”, SEL_WRAP circuit 93-8 (i.e., having the eighth ordinal position). The selector circuit 97 supplies the selected value to the SLS_MOD circuit 91. With this configuration, the SLS_MOD signal stored in the SLS_MOD circuit 91 becomes “8” in the next cycle.

In the ADD_OFFSET circuit 95 illustrated in FIG. 15, due to the fact that SLS is longer than M, the selector circuit 115 selects the value obtained by adding the value of the OFFSET signal to the data processing width P, and outputs the selected value as the OFFSET_NEXT signal. This OFFSET_NEXT signal is stored in the OFFSET register 94 illustrated in FIG. 13, and serves as the OFFSET signal in the next cycle. Accordingly, the value of the OFFSET signal increases by P in each cycle. In the cycle in which the value obtained by the addition circuit 111 adding P to the value of the OFFSET signal becomes “32”, however, the value stored in the OFFSET register 112 is set to “1”, and the POP_NEXT signal is set to “1”. This POP_NEXT signal is output as the POP signal from the control circuit 46. Only the 5 lower-order bits of the value obtained by the addition circuit 111 adding P to the value of the OFFSET signal are stored in the OFFSET register 113, so that the OFFSET_NEXT signal only assumes a value ranging from “0” to “31”. Namely, the OFFSET value stored in the OFFSET register 94 assumes cyclically repeating values within a range of “0” to “31”. In this manner, the OFFSET signal and the POP signal as in the example illustrated in FIG. 10 are generated. In FIG. 10, the OFFSET value is illustrated by including a value of the 6-th bit, so that a value of “32” appears.

A description will be given of another example of the operation of the control circuit 46 by referring to FIG. 13 through FIG. 15 as well as FIG. 12. In the initial state, the SLS_MOD signal stored in the SLS_MOD circuit 91 is “0”. The OFFSET signal stored in the OFFSET register 94 is “0”.

In the example illustrated in FIG. 12, due to the fact that SLS is shorter than or equal to M, the selector circuit 104 illustrated in FIG. 14 selects the SLS_MOD signal. In the case of the SEL_WRAP circuit 93-1, thus, the selection control signal SEL output therefrom is set to “0”. Further, the value “1” obtained by adding “1” to the SLS_MOD signal is output as the SLS_MOD_NEXT signal. In the case of the next SEL_WRAP circuit 93-2, the SLS_MOD signal applied thereto is the SLS_MOD_NEXT signal having a value of “1” supplied from the preceding stage, so that the selection control signal SEL output therefrom is “1”, and the value of the SLS_MOD_NEXT signal output therefrom is set to “2”. The rest is similar to the above. In the case of the SEL_WRAP circuit 93-n (n: natural number smaller than SLS), the selection control signal SEL output therefrom is “n−1”, and the SLS_MOD_NEXT signal output therefrom is “n”.

In the example illustrated in FIG. 12, the stream length SLS is 12. In the case of the SEL_WRAP circuit 93-12, thus, the output of the comparator circuit 105 illustrated in FIG. 14 is set to “1”, so that the selector circuit 107 selects “0”, thereby setting the value of the SLS_MOD_NEXT signal to “0”. As a result, the selection control signals SEL00 through SEL31 cyclically repeat values in the range of “0” to “11” as in the 0-th cycle illustrated in FIG. 12.

The selector circuit 97 receives SLS_MOD_NEXT output from each of the SEL_WRAP circuits 93-1 through 93-32. The selector circuit 97 further receives the value obtained by subtracting “1” from the data processing width P, i.e., “7” in this example, as a selection control signal. The selector circuit 97 selects the SLS_MOD_NEXT signal having a value of “8” output from the 7-th, as counted when the starting number is “0”, SEL_WRAP circuit 93-8 (i.e., having the eighth ordinal position). The selector circuit 97 supplies the selected value to the SLS_MOD circuit 91. With this configuration, the SLS_MOD signal stored in the SLS_MOD circuit 91 becomes “8” in the next cycle.

In the ADD_OFFSET circuit 95 illustrated in FIG. 15, due to the fact that SLS is shorter than or equal to M, the selector circuits 114 and 115 select the value “0” to output the POP_NEXT signal having a value of “1” and the OFFSET_NEXT signal having a value of “1”, respectively. With this arrangement, the OFFSET signal and the POP signal are both set to “0” as illustrated in the example of FIG. 12.

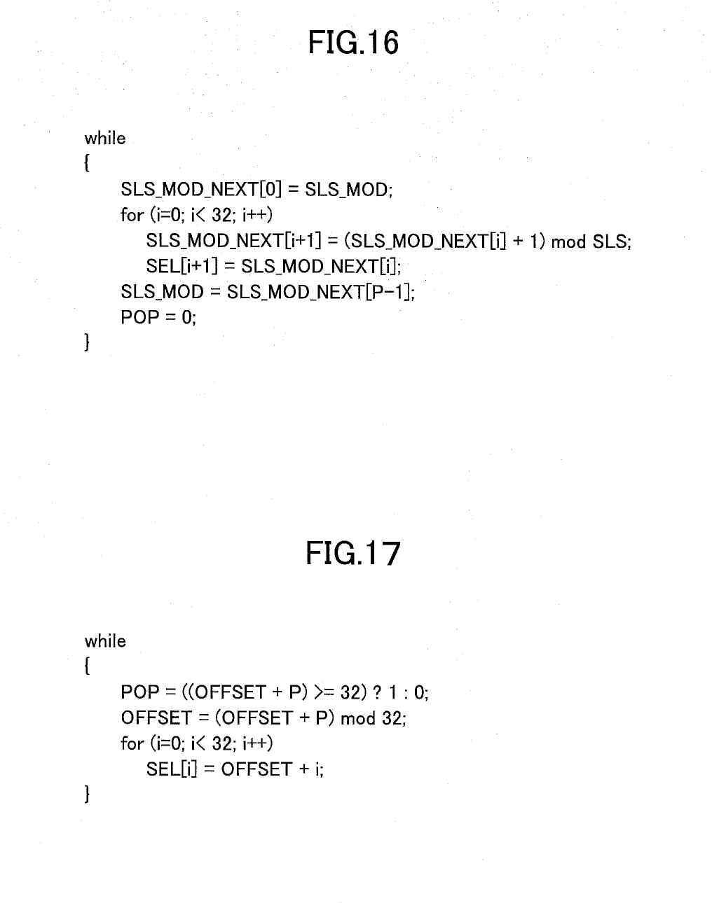

FIG. 16 is a drawing illustrating signal generation logic in the case of SLS≦M. In the case of SLS being shorter than or equal to M, the logic operation illustrated in FIG. 16 generates the SLS_MOD_NEXT signal, the selection control signals SEL, and the POP signal.

FIG. 17 is a drawing illustrating signal generation logic in the case of SLS>M. In the case of SLS being longer than M, the logic operation illustrated in FIG. 16 generates the POP signal, the OFFSET signal, and the selection control signals SEL.

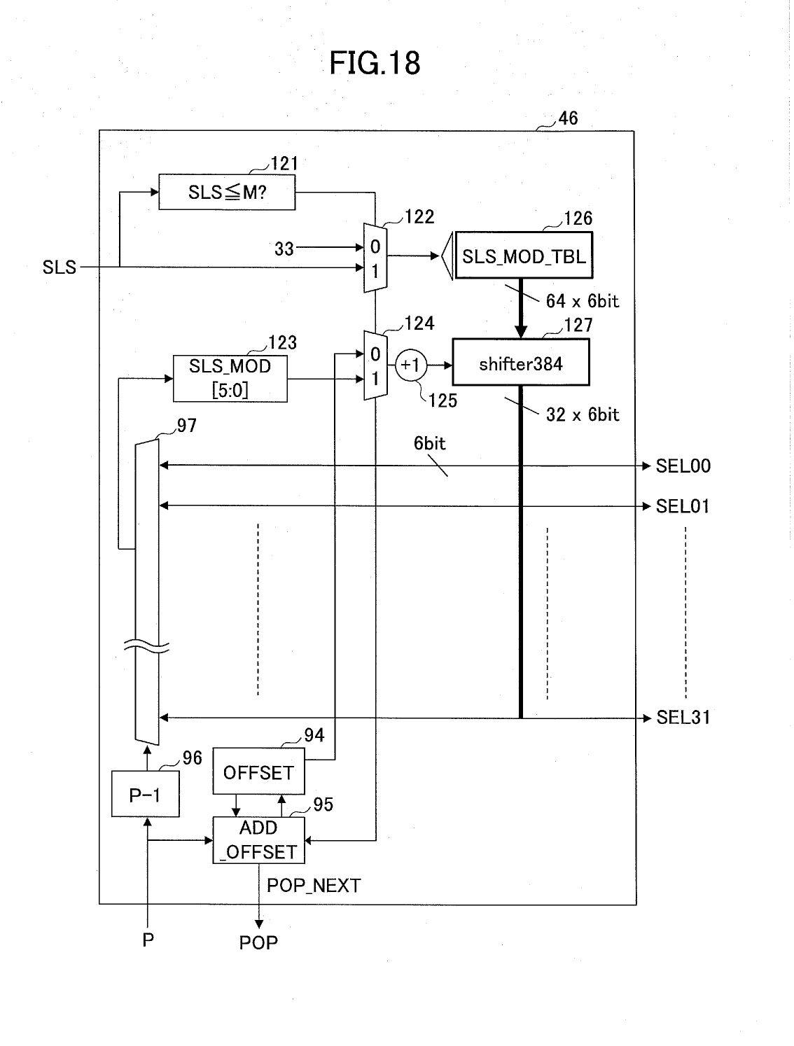

FIG. 18 is a drawing illustrating another example of the configuration of the control circuit 46. The control circuit 46 illustrated in FIG. 13 includes an SLS check circuit 121, a selector circuit 122, an SLS_MOD circuit 123, a selector circuit 124, a 1 addition circuit 125, an SLS_MOD table (SLS_MOD_TBL) 126, and a shifter circuit (shifter 384) 127. The control circuit 46 further includes an OFFSET register 94, an ADD_OFFSET circuit 95, a P subtraction circuit 96, and a selector circuit 97. In FIG. 18, the same or corresponding elements as those of FIG. 13 are referred to by the same or corresponding numerals, and a description thereof will be omitted as appropriate.

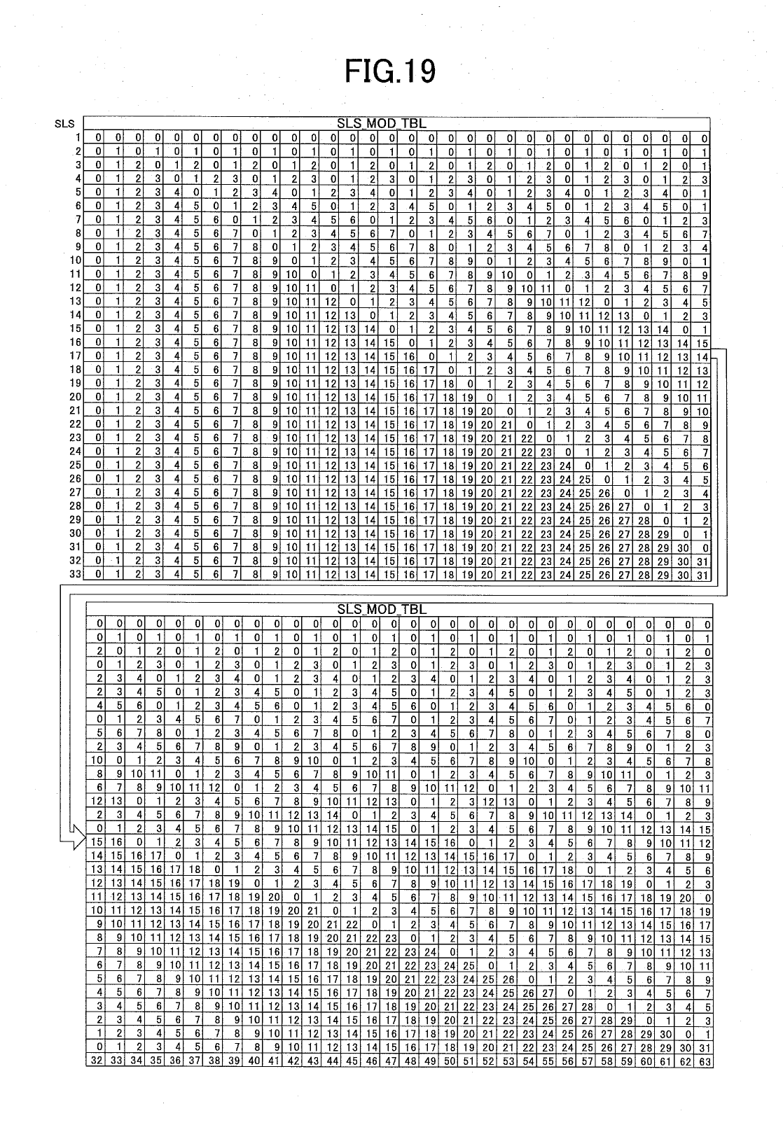

FIG. 19 is a drawing illustrating an example of data of the SLS_MOD table 126. As illustrated in FIG. 19, the SLS_MOD table 126 has 64 position data items for each of the 33 rows, i.e., for each of the 1-st row to the 33-rd row. The position data having a value of “0”, for example, selects the 0-th (i.e., leftmost) unit data item among the 64 unit data items of the data BUFOUT output from the combining circuit 83 illustrated in FIG. 9. Similarly, the position data having a value of n (n: integer ranging from “0” to “63”) selects the n-th unit data item among the 64 unit data items of the data BUFOUT output from the combining circuit 83 illustrated in FIG. 9. In this manner, the SLS_MOD table 126 has, as entries thereof, position data items each indicating a position at which a unit data item is selected from the data having the width 2M.

The shifter circuit 127 illustrated in FIG. 18 receives position data items from the SLS_MOD table 126, and shifts the received position data, followed by supplying the shifted position data to the selector circuit 84 (see FIG. 9) as the selection control signals SEL00 through SEL31. With this arrangement, the selector circuit 84 of the data selecting unit 45 selects appropriate unit data items.

In FIG. 18, the SLS check circuit 121 checks whether the stream length SLS is shorter than or equal to M. In the case of SLS being longer than M, the output of the SLS check circuit 121 is set to “0”, which causes the selector circuit 122 to select and output the value “33”. In this case, thus, the 33-rd row of the SLS_MOD table 126 is selected, so that the 64 position data items “0” through “63” as illustrated in FIG. 19 are output. At this time, the selector circuit 124 selects the value of the OFFSET signal stored in the OFFSET register 94, and the 1 addition circuit 125 adds “1” to the value selected by the selector circuit 124 to supply the result of the addition to the shifter circuit 127. The shifter circuit 127 shifts the 64 position data items supplied from the SLS_MOD table 126 in response to the value of the OFFSET signal to output the 64 shifted position data items as the selection control signals SEL. With this configuration, the selection control signals SEL as illustrated in FIG. 10 and FIG. 11 are generated.

In the case of SLS being shorter than or equal to M, the output of the SLS check circuit 121 is set to “1”, which causes the selector circuit 122 to select and output the value of the stream length SLS. As a result, in the case of the stream length SLS being “12” as illustrated in FIG. 12, for example, the twelfth row of the SLS_MOD table 126 is selected. Namely, the 64 position data items cyclically repeating values from “0” to “11” as illustrated in the twelfth row in FIG. 19 are output from the SLS_MOD table 126. At this time, the selector circuit 124 selects the value of the SLS_MOD signal stored in the SLS_MOD circuit 123, and the 1 addition circuit 125 adds “1” to the value selected by the selector circuit 124 to supply the result of the addition to the shifter circuit 127. The shifter circuit 127 shifts the 64 position data items supplied from the SLS_MOD table 126 in response to the value of the SLS_MOD signal to output the 64 shifted position data items as the selection control signals SEL. With this configuration, the selection control signals SEL as illustrated in FIG. 12 are generated.

In the control circuit 46 illustrated in FIG. 13, the SEL_WRAP circuits 93-1 through 93-32 are cascade-connected to form 32 stages. Due to this configuration, the time it takes for the SLS_MOD_NEXT signal to propagate through these stages is lengthy, which may give rise to a risk of failing to perform a selection operation at the data supply circuit 31 at sufficiently high speed. In contrast, the control circuit 46 illustrated in FIG. 18 has only a delay for a few stages in the shifter circuit 127, which enables the data supply circuit 31 to perform a selection operation at sufficiently high speed.

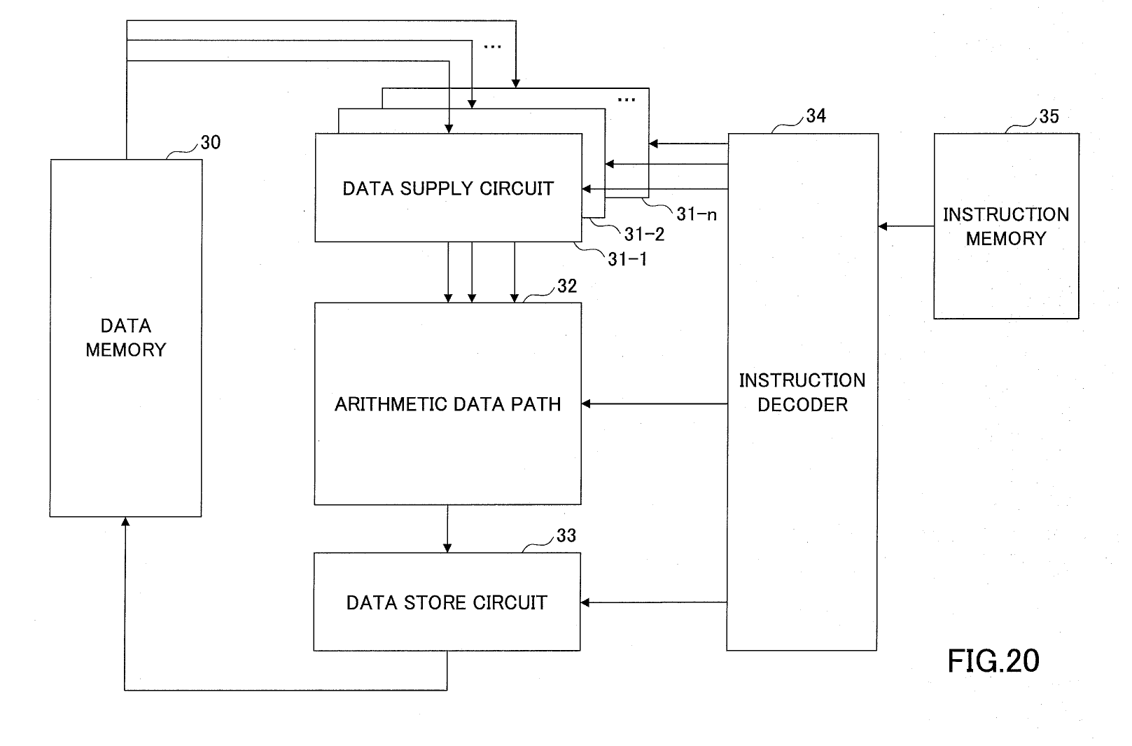

FIG. 20 is a drawing illustrating another example of the configuration of the arithmetic processing circuit. In FIG. 20, the same or corresponding elements as those of FIG. 2 are referred to by the same or corresponding numerals, and a description thereof will be omitted as appropriate.

The arithmetic processing circuit illustrated in FIG. 20 includes the data memory 30, a plurality of data supply circuits 31-1 through 31-n, the arithmetic data path (i.e., data arithmetic unit) 32, the data store circuit 33, the instruction decoder 34, and the instruction memory 35. The data supply circuits 31-1 through 31-n read n source data items (i.e., operands) stored in the data memory 30, respectively, for provision to the arithmetic data path 32. In the case of the two source data src0 and src1 being subjected to arithmetic operations as in the example illustrated in FIG. 4, for example, the data supply circuit 31-1 reads the source data src0, and the data supply circuit 31-2 reads the source data src1. The configuration and operation of each of the data supply circuits 31-1 through 31-n are basically the same as or similar to the configuration and operation of the data supply circuit 31 previously described. The arithmetic processing circuit illustrated in FIG. 20 can handle n source data items (i.e., operands).

Further, the present invention is not limited to these embodiments, but various variations and modifications may be made without departing from the scope of the present invention.

For example, the description given in connection with FIG. 3 and FIG. 4 has been directed to a case in which the operands are matrices, and the arithmetic data path 32 performs matrix operations in parallel. The data supply circuit of the present disclosures is not limited to a particular type of arithmetic operation such as a matrix operation, and is applicable to an arithmetic operation in general. Namely, the data supply circuit 31 is applicable to an arithmetic processing circuit in general in which the data processing width P (=UL×SIMD) defined by the unit data size UL and the SIMD width is variable.

According to at least one embodiment, data retrieved from memory can be efficiently supplied to an arithmetic unit in response to the requested computation process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A data supply circuit, comprising:
a buffer configured to store a plurality of data items each having a first width;
a memory access unit configured to read source data stored in a memory and to store the source data as one or more data items each having the first width in the buffer; and
a selection control unit configured to repeat multiple times an operation of reading a data item having a second width shorter than or equal to the first width to read a plurality of data items each having the second width contiguously and sequentially from the buffer and configured to continue to read from a head end of the source data upon a read portion reaching a tail end of the source data.

2. The data supply circuit as claimed in claim 1, wherein the memory access unit stores only once in the buffer a data item both having the first width and including the source data wherein the data width of the source data is shorter than or equal to the first width, and the selection control unit selects consecutive unit data items, a total combined width of which is equal to the second width, from a data portion corresponding to the source data of the data item having the first width stored in the buffer, thereby reading the data items having the second width consecutively and sequentially.

3. The data supply circuit as claimed in claim 1, wherein the memory access unit reads from the memory a plurality of data items each having the first width obtained by dividing the source data for consecutive storage in the buffer wherein the data width of the source data is longer than the first width, and continues to read from the head end of the source data upon a read portion reaching the tail end of the source data such that the head end of the source data next follows the tail end of the source data without a gap in the buffer, and the selection control unit selects consecutive unit data items, a total combined width of which is equal to the second width, from the plurality of data items each having the first width stored in the buffer, thereby reading the data items having the second width consecutively and sequentially.

4. The data supply circuit as claimed in claim 1, wherein the selection control circuit includes:
a selector circuit configured to select consecutive unit data items having a total combined width thereof equal to the second width as specified by a selection control signal from data having twice the first width produced by placing side by side a data item having the first width and a next data item having the first width;
a table that has position data items stored therein each indicating a position at which a unit data item is selected from the data having twice the first width; and
a shifter circuit configured to receive position data items from the table, to shift the received position data items, and to supply the shifted position data items to the selector circuit as the selection control signal.

5. An arithmetic processing circuit, comprising:
a memory;
one or more data supply circuits coupled to the memory;
a data arithmetic unit coupled to the one or more data supply circuits; and
a data store circuit coupled to the data arithmetic unit and to the memory,
wherein each of the one or more data supply circuits includes:
a buffer configured to store a plurality of data items each having a first width;
a memory access unit configured to read source data stored in memory and to store the source data as one or more data items each having the first width in the buffer; and
a selection control unit configured to repeat multiple times an operation of reading a data item having a second width shorter than or equal to the first width to read a plurality of data items each having the second width contiguously and sequentially from the buffer and configured to continue to read from a head end of the source data upon a read portion reaching a tail end of the source data.

6. A data supply method, comprising:
reading source data stored in memory to store the read source data as one or more data items each having a first width in a buffer; and
repeating multiple times an operation of reading a data item having a second width shorter than or equal to the first width to read a plurality of data items each having the second width contiguously and sequentially from the buffer, and continuing to read from a head end of the source data upon a read portion reaching a tail end of the source data.
